(19) United States
(12) Patent Application Publication
(10) Pub. No.: US 2025/0220594 A1
(43) Pub. Date: Jul. 3, 2025

(54) Adaptive Power Mode Control in Network Devices

(71) Applicant: Cisco Technology, Inc., San Jose, CA (US)

(72) Inventors: Vishal S. Desai, San Jose, CA (US); Ardalan Alizadeh, Campbell, CA (US); Peiman Amini, Fremont, CA (US)

(21) Appl. No.: 18/795,044

(22) Filed: Aug. 5, 2024

Related U.S. Application Data
(60) Provisional application No. 63/615,721, filed on Dec. 28, 2023.

(51) Int. Cl. H04W 52/36; H04W 52/02; H04W 52/14

(52) U.S. Cl. CPC H04W 52/367; H04W 52/0245; H04W 52/143

(57) ABSTRACT

Devices, systems, methods, and processes for adaptive power mode control in network devices are described herein. The deployment of access points (APs) introduces various challenges due to high-density AP deployments and varying interference levels. An AP executes an adaptive mode control logic to dynamically adjust transmission power and switch between Low Power Indoor (LPI) mode and Standard Power (SP) mode based on real-time assessment of uplink and downlink signal strength parameters of associated user devices. The AP may further assess Radio Frequency proximity with neighboring APs to determine optimal cell size and identify maximum transmission power limits (T_{MAX}) within the LPI and SP modes. To ensure seamless communication, the AP switches to the SP mode if the T_{MAX} in the LPI mode does not provide adequate uplink and downlink coverage to the associated user devices. This dynamic control minimizes interference, improves data rates, and supports seamless network integration.

This application claims the benefit of U.S. Provisional Patent Application No. 63/615,721, filed Dec. 28, 2023, which is incorporated by reference herein in its entirety.

The present disclosure relates to wireless communication systems. More particularly, the present disclosure relates to adaptive power mode control in network devices.

### BACKGROUND

The advent of 6 Gigahertz “GHz” spectrum for wireless networks represents a significant leap forward in wireless technology, offering increased bandwidth and reduced congestion compared to 2.4 GHz and 5 GHz bands. This new frequency range promises higher data rates, lower latency, and improved overall network performance, making it an important development for supporting the growing demand for wireless connectivity in modern environments.

However, deployment of 6 GHz Access Points (APs) introduces a unique set of challenges. When APs are positioned close to each other, the need for large cell sizes is eliminated. This is primarily due to the likelihood of inter-AP interference between overlapping basic service sets (OBSSs), which can degrade the overall performance of the network. Consequently, optimizing the deployment and configuration of 6 GHz APs is very important to ensure efficient and reliable wireless connectivity.

Further, 6 GHz APs can be operated in either Low Power Indoor (LPI) mode or Standard Power (SP) mode. Typically, the SP mode supports a higher Equivalent Isotropic Radiated Power (EiRP) budget compared to the LPI mode. This variation presents a unique challenge in determining the optimal power mode for AP operation.

### SUMMARY OF THE DISCLOSURE

Systems and methods for facilitating adaptive power mode control in network devices in accordance with embodiments of the disclosure are described herein. In some embodiments, a device includes a processor, a transceiver operable in one of a Low Power Indoor (LPI) mode or a Standard Power (SP) mode, and a memory communicatively coupled to the processor, wherein the memory includes a mode control logic that is configured to assess one or more signal strength parameters of a network device communicatively coupled to the device, evaluate, based on the one or more signal strength parameters, whether a power budget associated with the LPI mode provides an uplink coverage and a downlink coverage to the network device, and determine whether to switch the transceiver from the LPI mode to the SP mode based on the evaluation.

In some embodiments, the one or more signal strength parameters include an uplink signal strength parameter.

In some embodiments, the uplink signal strength parameter corresponds to a Received Signal Strength Indicator (RSSI) uplink value of the network device.

In some embodiments, to assess the uplink signal strength parameter, the mode control logic is further configured to compare the uplink signal strength parameter with an uplink signal strength threshold, and determine whether the uplink signal strength parameter is less than the uplink signal strength threshold based on the comparison.

In some embodiments, in response to determining that the uplink signal strength parameter is less than the uplink signal strength threshold, the mode control logic is further configured to determine a transmission power of the network device.

In some embodiments, the mode control logic is further configured to compare the transmission power with a maximum transmission power allowed to the network device in the LPI mode.

In some embodiments, the mode control logic determines to maintain the transceiver in the LPI mode in response to the transmission power being less than the maximum transmission power.

In some embodiments, the mode control logic is further configured to transmit, in response to the transmission power being less than the maximum transmission power, a signal that causes the network device to increase the transmission power.

In some embodiments, in response to the transmission power being equal to the maximum transmission power, the mode control logic evaluates that the power budget associated with the LPI mode is insufficient to provide the uplink coverage to the network device.

In some embodiments, in response to the power budget being insufficient, the mode control logic is further configured to switch the transceiver from the LPI mode to the SP mode, and transmit, based on the transceiver operating in the SP mode, a signal that configures the network device to operate in the SP mode.

In some embodiments, the one or more signal strength parameters include a downlink signal strength parameter.

In some embodiments, the downlink signal strength parameter corresponds to an RSSI downlink value of the network device.

In some embodiments, to assess the downlink signal strength parameter, the mode control logic is further configured to obtain a beacon report from the network device, determine the downlink signal strength parameter from the beacon report, and compare the downlink signal strength parameter with a downlink signal strength threshold.

In some embodiments, in response to the downlink signal strength parameter being less than the downlink signal strength threshold, the mode control logic evaluates that the power budget associated with the LPI mode is insufficient to provide the downlink coverage to the network device.

In some embodiments, the mode control logic is further configured to determine whether the network device is a sticky client.

In some embodiments, the mode control logic is further configured to switch the transceiver from the LPI mode to the SP mode, and increase a downlink transmission power of the transceiver.

In some embodiments, the mode control logic is further configured to assess a Radio Frequency (RF) proximity of the device with at least one neighboring device, and determine a device cell size based on the assessed RF proximity with the at least one neighboring device.

In some embodiments, the mode control logic is further configured to identify a maximum downlink transmission power allowed in the SP mode based on the determined device cell size.

In some embodiments, a mode control logic is configured to assess one or more signal strength parameters of a network device communicatively coupled to the device and a Radio Frequency (RF) proximity of the device with at least one neighboring device, evaluate, based on the one or more signal strength parameters and the RF proximity, whether a power budget associated with the LPI mode provides an uplink coverage and a downlink coverage to the network device, and determine whether to switch the transceiver from the LPI mode to the SP mode based on the evaluation.

In some embodiments, a method includes assessing one or more signal strength parameters of a network device in communication with an access point, evaluating, based on the one or more signal strength parameters, whether a power budget associated with a Low Power Indoor (LPI) mode of the access point provides an uplink coverage and a downlink coverage to the network device, and determining whether to switch the access point from the LPI mode to a Standard Power mode based on the evaluation.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a schematic block diagram of a call flow in a power management system in accordance with various embodiments of the disclosure;

FIG. 3 is a conceptual network diagram of various environments in which a mode control logic may operate in accordance with various embodiments of the disclosure;

FIG. 4 is a conceptual block diagram of a wireless network in accordance with various embodiments of the disclosure;

FIG. 5 is a conceptual diagram depicting an example scenario for adaptive power mode control by an access point (AP) in accordance with various embodiments of the disclosure;

FIGS. 6A and 6B collectively illustrate a flowchart showing a process for adaptive power mode control by an AP in accordance with various embodiments of the disclosure;

FIG. 7 is a flowchart showing a process for adaptive power mode control by an AP based on an uplink coverage check in accordance with various embodiments of the disclosure;

FIG. 8 is a flowchart showing a process for adaptive power mode control by an AP based on a downlink coverage check in accordance with various embodiments of the disclosure;

FIG. 9 is a flowchart showing a process for adaptive power mode control by an AP in accordance with various embodiments of the disclosure; and

FIG. 10 is a conceptual block diagram of a device suitable for configuration with a mode control logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can facilitate adaptive power mode control in Access Points (APs). The current technologies attempting power control often fall short in environments with high-density access point (AP) deployments and varying interference levels. A significant limitation of existing solutions is their inability to dynamically adapt to the unique power requirements of 6 Gigahertz “GHz” APs. 6 GHz APs can be operated in either Low Power Indoor (LPI) mode or Standard Power (SP) mode. The SP mode supports a higher Equivalent Isotropic Radiated Power (EiRP) budget compared to the LPI mode.

This variation presents a unique challenge in determining the optimal power mode for AP operation. For example, in scenarios where APs are permitted to operate in the SP mode, there may still be a necessity to maintain a low transmission power based on Radio Resource Management (RRM) decisions. Further, static power mode settings can lead to suboptimal performance, either by causing excessive interference or failing to provide adequate coverage. Additionally, user devices' uplink transmission power for both LPI and SP modes is 6 decibels “dB” lower than the AP's regulatory EiRP maximum, resulting in a smaller uplink cell size compared to a downlink cell size, which introduces further challenges. For example, there can be situations where a user device may receive AP's signals but may be unable to transmit signals back to the AP. Moreover, the user device can be hidden due to physical obstructions, further complicating reliable communication. The complexities of power mode operation, inter-AP interference, and uplink limitations underscore the need for meticulous deployment strategies to optimize 6 GHz network performance.

Moreover, user devices' uplink transmission power for both LPI and SP modes is 6 decibels “dB” lower than the AP's regulatory EiRP maximum, resulting in a smaller uplink cell size compared to a downlink cell size. Such discrepancy may introduce several challenges. For example, there can be situations where a user device can receive AP's signals but cannot transmit signals back to the AP. Additionally, user devices might be located in areas with physical obstructions, making them effectively hidden from the associated AP. These challenges underscore the complexities of deploying and managing 6 GHz networks.

The present disclosure provides an AP (e.g., a network device or any other network node) that can address the abovementioned challenges by dynamically adjusting power settings based on real-time conditions and measurements. In many embodiments, the AP may be configured to send to and receive data from a plurality of user devices in a network. The user devices can also be referred to as stations, client devices, or the like. The AP may transmit data to these user devices via downlink channels and receive data from the user devices via uplink channels.

In several embodiments, the AP may incorporate a transceiver capable of operating in either an LPI mode or an SP mode, at any given point in time. The transceiver may refer to a device that integrates both a transmitter and receiver and supports Wi-Fi signals across multiple bands, including but not limited to 2.4 GHz, 5 GHz, 6 GHz, or the like. Additionally, the transceiver can be configured to accommodate communications in extended 6 GHz spectrum introduced with Wi-Fi 6E (802.11ax), allowing access to higher frequency bands. Typically, the power radiated by a transceiver is measured as Effective Isotropic Radiated Power (EiRP). EiRP often accounts for both the antenna gain and the power supplied to it, providing a comprehensive view of the radiated power. In various embodiments, EiRP budget in the LPI mode may be lower as compared to EiRP budget in the SP mode. In other words, the LPI mode may be a configuration for Wi-Fi transceivers that limits their transmission power to lower levels suitable for indoor use, whereas the SP mode may be a configuration for Wi-Fi transceivers that allows higher transmission power levels suitable for outdoor or high-density environments.

In numerous embodiments, the AP may be configured to implement a mode control logic that enables the AP to dynamically control power mode settings based on real-time conditions and measurements. For example, the AP may be configured to dynamically control power settings based on at least one of signal strength parameters of associated user devices or proximity with neighboring APs.

In a number of embodiments, the AP may be configured to assess at least one of an uplink signal strength parameter and a downlink signal strength parameter of an associated user device. For example, the AP may assess a Received Signal Strength Indicator (RSSI) uplink value or an RSSI downlink value of the associated user device. The term “RSSI” may refer to a measurement of power present in a received radio signal. The downlink RSSI value may relate to the signal strength of a radio signal from the AP to the user device and the uplink RSSI value may relate to the signal strength of a radio signal from the user device to the AP. In an example, the AP may assess the downlink signal strength parameter by obtaining a beacon report from the user device. The beacon report obtained from the user device may include, for example, a timestamp indicating the exact time of report generation, channel information detailing the current or monitored channel number and bandwidth, and signal strength measurements such as downlink RSSI value from associated and neighboring APs. Additionally, the beacon report may include neighbor information, for example, nearby APs' Service Set Identifier (SSID), a Basic Service Set Identifier (BSSID), signal strength, and channel details. Further, the AP may assess the uplink RSSI value based on an uplink traffic from the user device to the AP.

In a variety of embodiments, the AP may further assess Radio Frequency (RF) proximity with neighboring APs and determine, based on the assessed RF proximity, a device cell size required to provide optimal coverage without blind spots. The device cell size may be defined as a function of minimum and maximum transmission power levels allowed to the AP within the network.

In further embodiments, the AP may be configured to evaluate whether a power budget associated with the LPI mode provides an uplink coverage and a downlink coverage to the user device. The evaluation can be based on the one or more signal strength parameters. In other words, the AP may determine whether operating the transceiver in the LPI mode would offer adequate uplink and downlink coverage to the user device.

In more embodiments, the AP may be configured to determine whether to switch the transceiver from the LPI mode to the SP mode based on the evaluation. In other words, if the power budget of the LPI mode does not satisfy power requirements for at least one of the optimal cell size, the uplink coverage, or the downlink coverage, the AP may switch the transceiver to the SP mode to increase the power budget.

In yet more embodiments, if operating the transceiver in the LPI mode results in weak downlink signal strength at the edges of AP's cell, the AP may switch the transceiver to the SP mode. The increase in power budget may allow the AP to extend its coverage area, reducing dead zones and ensuring better connectivity and optimal cell overlap with neighboring APs.

In still more embodiments, to assess the uplink signal strength parameter, the AP may be configured to compare the uplink signal strength parameter with an uplink signal strength threshold and determine whether the uplink signal strength parameter is less than the uplink signal strength threshold or not. In further embodiments, the AP may be configured to estimate an RF proximity with the user device, for example, via Fine Timing Measurement (FTM) ranging. If the AP needs to ensure optimal uplink coverage, the AP may combine uplink signal strength parameter with FTM ranging and determine whether to switch from the LPI mode to the SPI mode. For example, in response to determining that the uplink signal strength parameter is less than the uplink signal strength threshold, the AP can either configure the user device to increase corresponding transmission power to the maximum transmission power or switch from the LPI mode to the SP mode if the user device is already at the maximum transmission power. In still yet more embodiments, the AP may request the user device to increase the transmission power by transmitting any one of a Dynamic Transmit Power Control (DTPC) frame, o-DS action frame, or the like.

In many further embodiments, if the RF density and downlink coverage do not demand higher transmission power, the AP may continue to operate at the previous transmission power even after switching to the SP mode. Switching to the SP mode may increase an EiRP budget of the user device. This ensures that the newly switched SP mode does not induce any additional Co-Channel Interference (CCI) while the uplink EiRP budget can substantially benefit the user device. The mode control logic may receive new uplink RSSI value benchmarks on the user device, and if a further increase in user device's transmission power is needed, the AP can request the user device via any one of a DTPC frame, o-DS action frame, or the like.

In yet further embodiments, to assess the downlink signal strength parameter, the AP may compare the downlink signal strength parameter with a downlink signal strength threshold. In response to the downlink signal strength parameter being less than the downlink signal strength threshold, the AP may evaluate that the power budget associated with the LPI mode is insufficient to provide the downlink coverage to the network device. For example, if the reported downlink signal strength of the user device is −85 decibel-milliwatts “dBm” and the downlink signal strength threshold is −80 dBm, the AP may recognize that the current downlink signal strength is weak and may not provide seamless communication. In such a scenario, the AP may evaluate that the LPI mode's power budget is not sufficient to provide effective downlink coverage to the user device. As a result, the AP may switch the transceiver to the SP mode and increase the downlink signal strength.

In still yet further embodiments, the AP may be further configured to determine whether the user device is a sticky client prior to switching to the SP mode. For example, a mobile user device moving within a building having multiple APs (e.g. AP₁, AP₂, . . . , APₙ) may initially connect to AP1, located near the entrance. As the user device comes closer to AP₂, which provides a stronger signal compared to AP₁, the user device should ideally switch to AP2. However, if the user device remains connected to AP1 despite the weaker signal, the user device may be determined as a sticky client. The AP can identify such sticky clients by monitoring signal strengths and connection patterns reported in the beacon reports. If the AP determines that the user device is a sticky client, instead of switching to the SP mode to provide sufficient downlink coverage, the AP may continue operating in the LPI mode and may steer the user device to reassociate with a nearer and stronger AP. For example, the AP may reduce the transmission power or send disassociation frames to the user device to steer towards the neighboring AP. However, if the user device is a non-sticky client, the AP switches the transceiver from the LPI mode to the SP mode as described above.

In numerous additional embodiments, the AP may be further configured to identify a maximum downlink transmission power allowed in the SP mode based on the determined device cell size. For example, once the optimal device cell size is determined, the AP may identify the maximum downlink transmission power that can be used in the SP mode without causing interference with neighboring APs. In a scenario where the determined cell size is small due to the RF proximity of neighboring APs, the AP may limit the downlink transmission power to be less than the maximum possible transmission power for the SP mode. This approach ensures efficient spectrum utilization and minimizes interference, resulting in a more stable and high-performing wireless network.

Thus, by measuring the uplink and downlink RSSI values of a user device, an AP can determine the optimal power mode (e.g., the LPI mode or the SP mode), thereby enhancing the efficiency and performance of wireless communication networks. The AP can accurately assess uplink and downlink RSSI values in real-time to make informed decisions about power mode adjustments, optimizing signal strength and network coverage. Additionally, the AP can continuously monitor and adjust the power mode based on precise RSSI values. For example, the AP can maintain the previous transmission power level (in decibel-milliwatts “dBm”) even after switching to the SP mode. This allows wireless user devices to benefit from a higher uplink power budget when necessary. For example, a dual-mode station (e.g., user device) can increase uplink transmission power from 12 dBm in the LPI mode to 30 dBm in the SP mode, significantly improving the uplink Signal to Noise Ratio (SNR) and overall link quality. Consequently, the AP can operate at an optimal power level, reducing interference and enhancing data transmission rates, thereby extending the battery life of mobile devices and reducing AP power consumption. This also improves the reliability and stability of wireless communication in the 6 GHz band, providing a more robust and consistent user experience. The AP can seamlessly integrate with existing wireless network infrastructure, allowing for easy implementation and deployment without significant modifications to current systems. Thus, a cost-effective solution for optimizing the power mode of 6 GHz APs is provided, minimizing the need for additional hardware or complex configurations, and reducing operational costs for network operators.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

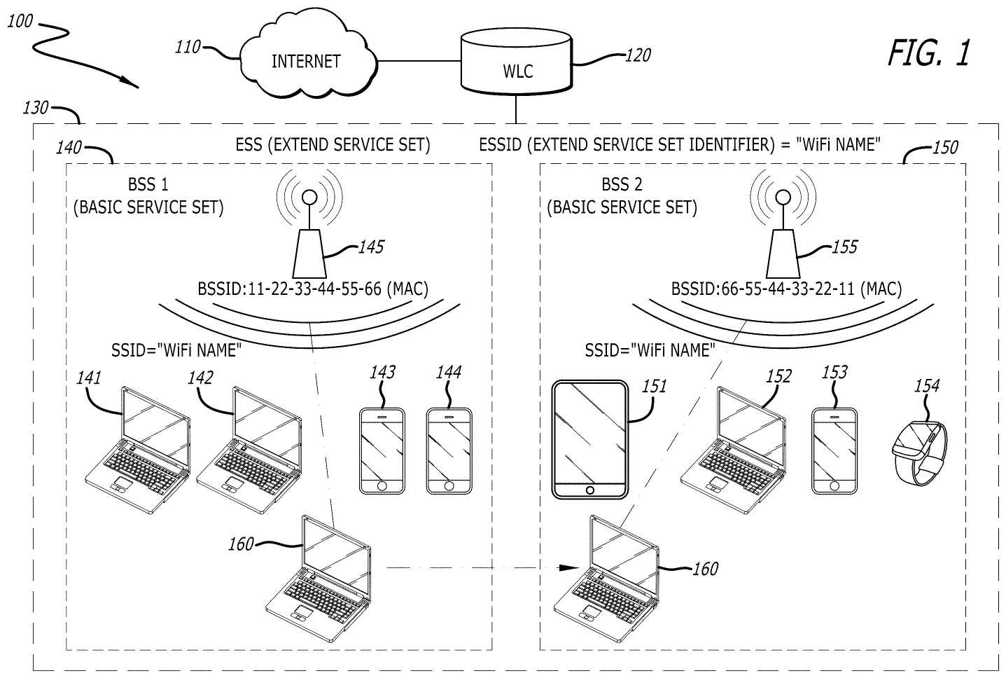

Referring to FIG. 1, a schematic block diagram of a wireless local networking system 100 in accordance with various embodiments of the disclosure is shown. Wireless local networking standards play a crucial role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes comprising devices like laptops, smartphones, or other Wi-Fi-enabled devices operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends a service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device is associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

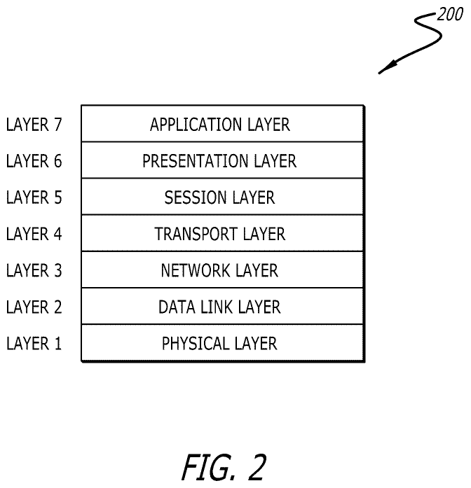

The network can include a variety of end user devices that connect to the network. These devices can sometimes be referred to as stations (i.e., “STAs”). The STAs may be associated with Wi-Fi 6E network and operate over 2.4 GHz and 5 GHz bands, just like Wi-Fi 6 networks and devices. The 6E STAs can also transmit data over the 6 GHz band unlocking extra bandwidths of up to 1200 MHz, comprising but not limited to 14 additional 80 MHz channels and 7 additional 160 MHz channels. Each device is typically configured with a medium access control (“MAC”) address in accordance with the IEEE 802.11 standard. As described in more detail in FIG. 2, a physical layer can also be configured to communicate over the wireless medium. Various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (a first BSS 1 140 and a second BBS 2 150). The ESS 130, first BSS 1 140, and second BSS 2 150 all broadcast and are configured with the same SSID “WiFi Name”, which can be a BSSID for each of the first BSS 1 140 and second BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance with the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIGS. 1 and 3-10 as required to realize a particularly desired embodiment.

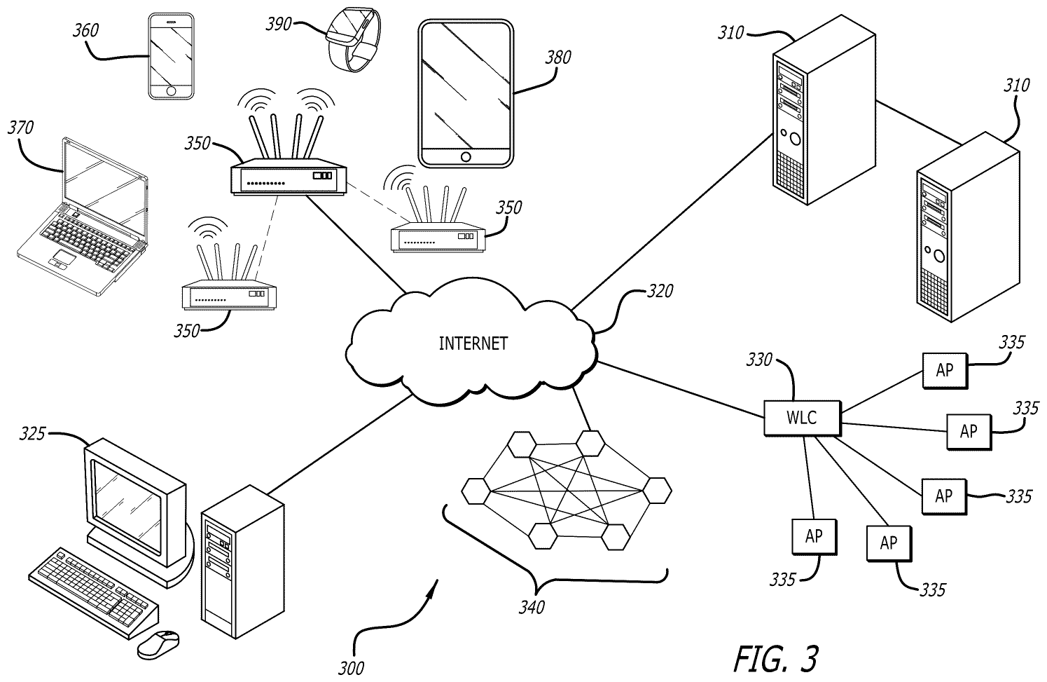

Referring to FIG. 3, a conceptual network diagram 300 of various environments in which a mode control logic may operate in accordance with various embodiments of the disclosure is shown. Those skilled in the art will recognize that the mode control logic can include various hardware and/or software deployments and can be configured in a variety of ways. In many embodiments, the mode control logic can be configured as a standalone device, exist as a logic in another network device, be distributed among various network devices operating in tandem, or remotely operated as part of a cloud-based network management tool. In further embodiments, one or more servers 310 can be configured with the mode control logic or can otherwise operate as the mode control logic. In many embodiments, the mode control logic may operate on one or more servers 310 connected to a communication network 320 (shown as the “Internet”). The communication network 320 can include wired networks or wireless networks. The mode control logic can be provided as a cloud-based service that can service remote networks, such as, but not limited to a deployed network 340.

However, in additional embodiments, the mode control logic may be operated as a distributed logic across multiple network devices. In the embodiment depicted in FIG. 3, a plurality of network access points (APs) 350 can operate as the mode control logic in a distributed manner or may have one specific device operate as the mode control logic for all of the neighboring or sibling APs 350. The APs 350 may facilitate Wi-Fi connections for various electronic devices, such as but not limited to, mobile computing devices including laptop computers 370, cellular phones 360, portable tablet computers 380, and wearable computing devices 390.

In further embodiments, the mode control logic may be integrated within another network device. In the embodiment depicted in FIG. 3, a wireless LAN controller (WLC) 330 may have an integrated mode control logic that the WLC 330 can use to monitor or control power consumption of the APs 335 that the WLC 330 is connected to, either wired or wirelessly. In still more embodiments, a personal computer 325 may be utilized to access and/or manage various aspects of the networking logic, either remotely or within the network itself. In the embodiment depicted in FIG. 3, the personal computer 325 communicates over the communication network 320 and can access the mode control logic of the servers 310, or the network APs 350, or the WLC 330.

Although a specific embodiment for various environments, in which the mode control logic may operate, suitable for carrying out the various steps, processes, methods, and operations described herein is discussed with respect to FIG. 3, any of a variety of systems and/or processes may be utilized in accordance with embodiments of the disclosure. In many non-limiting examples, the mode control logic may be provided as a device or software separate from the WLC 330 or the mode control logic may be integrated into the WLC 330. The elements depicted in FIG. 3 may also be interchangeable with other elements of FIGS. 1-2 and 4-10 as required to realize a particularly desired embodiment.

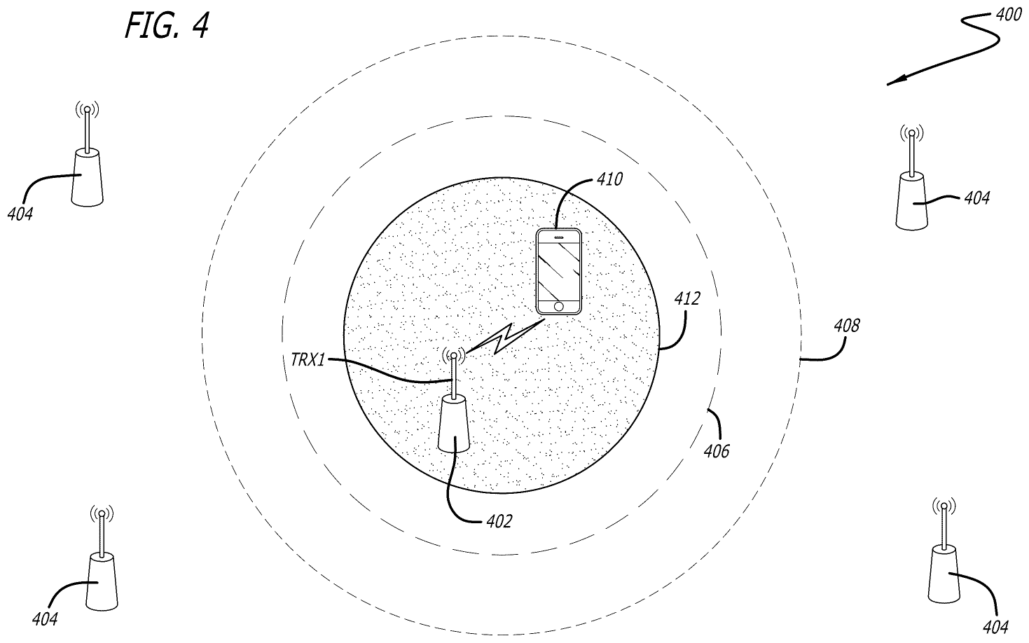

Referring to FIG. 4, a conceptual block diagram of a wireless network 400 in accordance with various embodiments of the disclosure is shown. The embodiments shown in FIG. 4 illustrate a scenario where the wireless network 400 includes a plurality of APs deployed in an area to provide wireless network connectivity to various user devices. For example, the wireless network 400 may include an AP 402 having several neighboring APs 404. The wireless network 400 can be set up in various environments. For example, the wireless network 400 can be confined within a building, with all APs 402, 404 located indoors. In another example, the wireless network 400 can also extend to outdoor areas with some APs placed outside the building. In yet other examples, the wireless network 400 can be established in open spaces, covering outdoor areas entirely. In such examples, all APs 402, 404 may be located outdoors.

In many embodiments, the AP 402 may include one or more transceivers, for example, a transceiver TRX1. The transceiver TRX1 may be operable in one of a Low Power Indoor (LPI) mode or a Standard Power (SP) mode, at any given point in time. The transceiver TRX1 may refer to a device that integrates both a transmitter and receiver and supports Wi-Fi signals across multiple bands, including but not limited to 2.4 GHz, 5 GHz, 6 GHz, or the like. Additionally, the transceiver TRX1 can be configured to accommodate communications in extended 6 GHz spectrum introduced with Wi-Fi 6E (802.11ax), allowing access to higher frequency bands. The power radiated by the transceiver TRX1 can be expressed as Effective Isotropic Radiated Power (EiRP). In various embodiments, EiRP budget in the LPI mode may be lower as compared to EiRP budget in the SP mode. For example, the LPI mode may configure the transceiver TRX1 to limit transmission power to levels appropriate for indoor use, whereas the SP mode may configure the transceiver TRX1 to permit higher transmission power levels suitable for outdoor environments or areas with high user density. A person of ordinary skill in the art would understand that stating the transceiver TRX1 is operating in LPI or SP mode is equivalent to stating the AP 402 is operating in the LPI or SP mode.

In FIG. 4, a first dotted circle 406 illustrates a boundary of a downlink coverage area for the AP 402 when the AP 402 is operating in the LPI mode. Similarly, a second dotted circle 408 denotes a boundary of a downlink coverage area for the AP 402 when the AP 402 is operating in the SP mode at its maximum transmission power level. However, if the transmission power of the AP 402 is less than the maximum transmission power level, the downlink coverage area can be smaller than the downlink coverage area depicted by the second dotted circle 408.

In a number of embodiments, the AP 402 may be configured to assess a Radio Frequency (RF) proximity with neighboring APs 404 and determine a cell size based on the RF proximity with the neighboring APs 404. The device cell size may be determined to provide optimal coverage without blind spots. In many examples, the determined cell size may be defined as a function of minimum and maximum transmission power levels allowed to the AP 402 within the wireless network 400. Based on the minimum power level allowed to the AP 402, the AP 402 may determine whether the AP 402 can operate in the LPI mode. For example, if the minimum power level allowed to the AP 402 is greater than the EiRP budget in the LPI mode, the AP 402 may decide not to operate in the LPI mode and may switch to the SP mode. Further, the maximum power level allowed to the AP 402 may define a maximum downlink coverage area that the AP 402 can cater to.

In more embodiments, the AP 402 may be communicatively coupled to the user device 410. For the sake of illustration, the user device 410 is shown to be a mobile device; however, the scope of the disclosure is not limited to it. Additional examples of the user device 410 can include, but are not limited to, a laptop, a smartphone, a tablet, a phablet, a desktop computer, Internet of Things (IoT) devices, gaming consoles, wearable devices, smart home assistants and appliances, entertainment, and media devices, or the like. In FIG. 4, a circle 412 illustrates a boundary of an uplink coverage area for the user device 410.

In still more embodiments, the AP 402 may be configured to implement a mode control logic that enables the AP 402 to dynamically control power mode settings based on real-time conditions and measurements. Examples of the real-time conditions assessed by the AP 402 may include signal strength parameters of the associated user devices, RF proximity with the neighboring APs 404, or the like. In other words, the AP 402 may dynamically control power settings based on the signal strength parameters of the user device 410 and/or the RF proximity with the neighboring APs 404. Signal strength parameters of the associated user devices may include an uplink signal strength parameter and a downlink signal strength parameter. Controlling the power settings may include determining whether to operate in the LPI mode or the SP mode, selecting an appropriate transmission power in accordance with the current mode of operation, or the like. In yet more embodiments, the uplink signal strength parameter can include a Received Signal Strength Indicator (RSSI) uplink value, an uplink Signal to Noise Ratio (SNR) value, or the like. Similarly, the downlink signal strength parameter can include an RSSI downlink value, a downlink SNR value, or the like. The term “RSSI” may refer to a measurement of power present in a received radio signal. The downlink RSSI value (interchangeably referred to as “RSSI downlink value” or “downlink RSSI”) may relate to the signal strength of a radio signal from the AP 402 to the user device 410 and the uplink RSSI value (interchangeably referred to as “RSSI uplink value” or “uplink RSSI”) may relate to the signal strength of a radio signal from the user device 410 to the AP 402.

In still yet more embodiments, the AP 402 may assess the downlink signal strength parameter by obtaining a beacon report from the user device 410. The beacon report obtained from the user device 410 may include, for example, a timestamp indicating the exact time of report generation, channel information detailing the current or monitored channel number and bandwidth, and signal strength measurements such as downlink RSSI and downlink SNR from the associated AP 402 and the neighboring APs 404. Additionally, the beacon report may include neighbor information, for example, nearby APs' SSID, a BSSID, signal strength, and channel details. The beacon report can be either solicited by the AP 402 or sent unsolicited by the user device 410. When solicited, the AP 402 may request specific information (for example, the signal strength measurements and the neighbor information) from the user device 410. Conversely, the user device 410 can also transmit unsolicited beacon reports, without a prior request from the AP 402, to share real-time observations and measurements with the AP 402. For example, the user device 410 can periodically transmit the beacon report to the AP 402.

In many embodiments, the AP 402 may assess the uplink signal strength parameter based on an uplink traffic from the user device 410 to the AP 402. For example, when the user device 410 transmits the uplink traffic to the AP 402, the AP 402 (e.g., the transceiver TRX1) may capture the incoming traffic and evaluate the uplink RSSI of the uplink traffic.

In a variety of embodiments, upon accessing the real-time conditions (such as the signal strength parameters of the associated user devices, RF proximity with the neighboring APs 404, etc.), the AP 402 may be configured to evaluate whether a power budget (e.g., EiRP budget) associated with the LPI mode can provide an uplink coverage and a downlink coverage to the user device 410. The evaluation can be based on the assessed signal strength parameters. In other words, the AP 402 may determine whether operating the transceiver TRX1 in the LPI mode would offer adequate uplink and downlink coverage to the user device 410. Adequate uplink and downlink coverage may refer to the capability of an AP to maintain strong and reliable wireless communication with a user device in both directions of data transmission. In other words, this means that the signal strength from the user device 410 to the AP 402 (uplink) and from the AP 402 to the user device 410 (downlink) should be sufficient to support the required data rates and ensure minimal latency and packet loss.

In additional embodiments, based on the evaluation, the AP 402 may be configured to determine whether to perform a mode switch operation or continue operating in the same mode. For example, if the AP 402 is currently operating in the LPI mode, the AP 402 may determine whether to switch the transceiver TRX1 from the LPI mode to the SP mode or continue operating in the LPI mode. However, if the AP 402 is currently operating in the SP mode, the AP 402 may determine whether to switch the transceiver TRX1 from the SP mode to the LPI mode or continue operating in the SP mode.

In an example scenario, the AP 402 may be operating in the LPI mode. Thus, if based on the evaluation the AP 402 determines that the power budget of the LPI mode does not satisfy power requirements for at least one of the optimal cell size, the uplink coverage, or the downlink coverage, the AP 402 may switch the transceiver TRX1 to the SP mode to increase the power budget. Similarly, if based on the evaluation the AP 402 determines that the power budget of the LPI mode satisfies the power requirements for the optimal cell size, the uplink coverage, and the downlink coverage, the AP 402 may continue operating in the LPI mode.

In another example scenario, the AP 402 may be operating in the SP mode. Thus, if based on the evaluation the AP 402 determines that the power budget of the LPI mode satisfies the power requirements for the optimal cell size, the uplink coverage, and the downlink coverage, the AP 402 may switch the transceiver TRX1 to the LPI mode from the SP mode and decrease the power budget, thus preventing energy wastage. Similarly, if based on the evaluation the AP 402 determines that the power budget of the LPI mode does not satisfy the power requirements for at least one of the optimal cell size, the uplink coverage, or the downlink coverage, the AP 402 may continue operating in the SP mode.

In the embodiments shown in FIG. 4, the AP 402 is assumed to be operating in the LPI mode. Further, based on assessing the signal strength parameters of the user device 410, the AP 402 may determine that the user device 410 has sufficient uplink and downlink coverage. As long as the downlink and the uplink coverage are strong, the AP 402 may continue to operate in the LPI mode.

Although a specific embodiment for a wireless network suitable for carrying out the various steps, processes, methods, and operations described herein is discussed with respect to FIG. 4, any of a variety of systems and/or processes may be utilized in accordance with embodiments of the disclosure. For example, the AP 402 may be configured to assess the RF proximity with the neighboring APs 404 and the signal strength parameters of the user device 410 at periodic time intervals. The elements depicted in FIG. 4 may also be interchangeable with other elements of FIGS. 1-3 and 5-10 as required to realize a particularly desired embodiment.

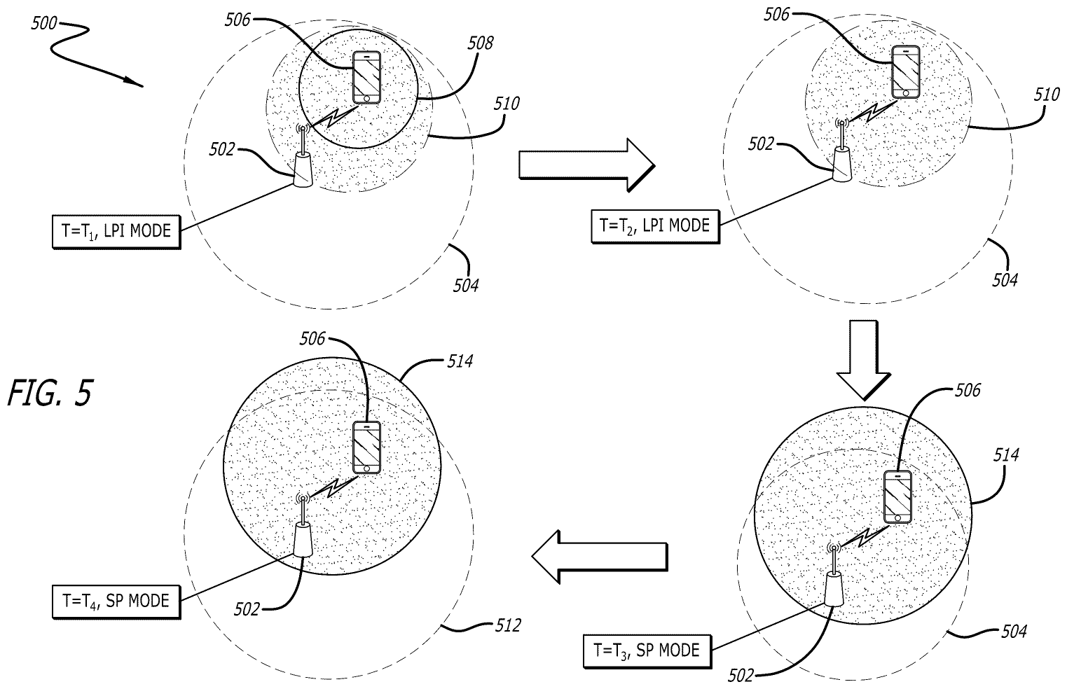

Referring to FIG. 5, a conceptual diagram depicting an example scenario 500 for adaptive power mode control by an AP in accordance with various embodiments of the disclosure is shown. The embodiments shown in FIG. 5 illustrate a scenario where an AP 502 is communicatively coupled to a user device 506.

In FIG. 5, it is assumed that the AP 502 is operating in the LPI mode at a first-time instance (T=T₁). Further, a first dotted circle 504 illustrates a boundary of a downlink coverage area of the AP 502 at the first time instance. A second circle 508 illustrates a boundary of an uplink coverage area of the user device 506 at the first-time instance. Furthermore, a third dotted circle 510 illustrates a boundary of a maximum uplink coverage area of the user device 506 when the user device 506 operates at its maximum transmission power level. Typically, user devices' uplink transmission power for both LPI and SP modes is 6 decibels “dB” lower than AP's regulatory EiRP maximum. As a result, uplink cell size (indicated by the third dotted circle 510) is smaller compared to a downlink cell size (indicated by the first dotted circle 504). Since at time T=T₁ the actual uplink coverage area (encompassed by the second circle 508) of the user device 506 is less than the maximum uplink coverage area (encompassed by the third dotted circle 510), the user device 506 is shown to be transmitting at a power lower than the maximum transmission power.

For the sake of illustration, the user device 506 is shown to be a mobile device; however, the scope of the disclosure is not limited to it. Additional examples of the user device 506 can include, but are not limited to, a laptop, a smartphone, a tablet, a phablet, a desktop computer, Internet of Things (IoT) devices, gaming consoles, wearable devices, smart home assistants and appliances, entertainment and media devices, or the like.

In a number of embodiments, the AP 502 may be configured to implement a mode control logic that enables the AP 502 to dynamically control power mode settings based on signal strength parameters of the user device 506. Signal strength parameters of the user device 506 may include an uplink signal strength parameter and a downlink signal strength parameter. Controlling the power settings may include determining whether to operate the AP 502 in the LPI mode or the SP mode, selecting an appropriate transmission power in accordance with the current mode of operation, or the like. In more embodiments, the uplink signal strength parameter can include an uplink RSSI value, an uplink SNR value, or the like. Similarly, the downlink signal strength parameter can include a downlink RSSI value, a downlink SNR value, or the like.

In yet more embodiments, the AP 502 may assess the downlink signal strength parameter by obtaining a beacon report from the user device 506. The beacon report obtained from the user device 506 may include, for example, a timestamp indicating the exact time of report generation, channel information detailing the current or monitored channel number and bandwidth, and signal strength measurements such as downlink RSSI and downlink SNR from the associated AP 502 and one or more neighboring APs. In many embodiments, the AP 502 may assess the uplink signal strength parameter based on an uplink traffic from the user device 506 to the AP 502.

In still more embodiments, to assess the uplink signal strength parameter, the AP 502 may be configured to compare the uplink signal strength parameter with an uplink signal strength threshold and determine whether the uplink signal strength parameter is less than the uplink signal strength threshold or not. Likewise, to assess the downlink signal strength parameter, the AP 502 may compare the downlink signal strength parameter with a downlink signal strength threshold and determine whether the downlink signal strength parameter is less than the downlink signal strength threshold or not.

In a variety of embodiments, upon accessing the signal strength parameters of the user device 506, the AP 502 may be configured to evaluate whether a power budget (e.g., EiRP budget) associated with the LPI mode can provide an uplink coverage and a downlink coverage to the user device 506. The evaluation can be based on the assessed signal strength parameters. For example, in response to determining that the uplink signal strength parameter is less than the uplink signal strength threshold, the AP 502 may determine that the uplink coverage is not adequate for the user device 506. However, in response to determining that the uplink signal strength parameter is greater than the uplink signal strength threshold, the AP 502 may determine that the uplink coverage is adequate for the user device 506. Likewise, in response to determining that the downlink signal strength parameter is less than the downlink signal strength threshold, the AP 502 may determine that the downlink coverage is not adequate for the user device 506. However, in response to determining that the downlink signal strength parameter is greater than the downlink signal strength threshold, the AP 502 may determine that the downlink coverage is adequate for the user device 506.

In still yet more embodiments, in response to determining that uplink coverage is not adequate for the user device 506, the AP 502 may attempt to determine a cause of inadequate uplink coverage. For example, the inadequate uplink coverage can be caused due to the user device 506 operating at a lower transmission power compared to the maximum allowed transmission power. In another example, the inadequate uplink coverage can be caused due to the AP 502 operating in the LPI mode which limits the maximum transmission power of the user device 506, for example, to EiRP maximum_{LPI}—6 dB. Thus, in order to determine the cause of inadequate uplink coverage, the AP 502 may determine a current transmission power level of the user device 506. In response to determining that the user device 506 is operating at a lower transmission power compared to the maximum allowed transmission power, the AP 502 may transmit a signal to the user device 506 to configure the user device 506 to increase the transmission power. The AP 502 may request the user device 506 to increase the transmission power by transmitting any one of a Dynamic Transmit Power Control (DTPC) frame, o-DS action frame, or the like. For example, the DTPC or o-DS action frames can be customized to instruct the user device 506 to increase the transmission power. However, in response to determining that the user device 506 is operating at the maximum allowed transmission power, the AP 502 may evaluate that the power budget associated with the LPI mode is insufficient to provide the uplink coverage to the user device 506.

In further embodiments, in response to determining that downlink coverage is not adequate for the user device 506, the AP 502 may attempt to determine a cause of inadequate downlink coverage. For example, the inadequate downlink coverage can be caused due to the user device 506 being a sticky client and not associating with another neighboring AP offering better downlink coverage. In another example, the inadequate downlink coverage can be caused due to the AP 502 operating in the LPI mode which has a lower power budget than required. Thus, in order to determine the cause of inadequate downlink coverage, the AP 502 may solicit a beacon report from the user device 506 to confirm if the user device 506 is a sticky client or not. If the beacon report indicates that the user device 506 is a sticky client, the AP 502 may transmit a signal to steer the user device 506 to connect to another neighboring AP offering a better connection. However, if the beacon report indicates that the user device 506 is a non-sticky client, the AP 502 may evaluate that the power budget associated with the LPI mode is insufficient to provide the uplink coverage to the user device 506.

In many further embodiments, if the AP 502 evaluates that the power budget associated with the LPI mode is insufficient to provide the uplink coverage or the downlink coverage to the user device 506, the AP 502 may switch from the LPI mode to the SP mode. If the AP 502 is already operating in the SP mode, the AP 502 may continue operating in the SP mode and may only adjust the power settings to meet the requirement.

Continuing to the example scenario 500, at the first-time instance (T=T₁), based on the assessment of the uplink and downlink signal strength parameters, the AP 502 may determine that the downlink coverage is sufficient; however, the uplink coverage is not sufficient. Further, AP 502 may determine that the user device 506 is operating at a lower transmission power compared to the maximum allowed transmission power. Thus, the AP 502 may transmit a signal to the user device 506 to configure the user device 506 to increase the transmission power. For example, the AP 502 may request the user device 506 to increase the transmission power by transmitting a DTPC frame.

In response to the DTPC frame, the user device 506 may increase the transmission power to the maximum transmission power allowed in the LPI mode. Consequently, at a second time instance (T=T₂, which is after the DTPC frame is received by the user device 506), the user device 506 increases the transmission power to the maximum transmission power allowed in the LPI mode (as indicated by dotted circle 510). Despite the user device 506 increasing its transmission power to the maximum allowed in the LPI mode, the AP 502 may determine that the uplink coverage is still not sufficient.

Consequently, at a third time instance (T=T₃), the AP 502 may switch from the LPI mode to the SP mode. The AP 502 may further transmit a signal to the user device 506 to configure the user device 506 to operate in the SP mode. As the user device 506 switches from the LPI mode to the SP mode, the power budget for the user device 506 increases. The increased uplink coverage area of the user device 506 is depicted by a fourth circle 514 in FIG. 5. Thus, providing sufficient uplink coverage to the user device 506. Since the downlink coverage was already sufficient and did not demand higher transmission power, the AP 502 may continue to operate at the previous transmission power even after switching to the SP mode. Switching to the SP mode may increase an EiRP budget of the user device 506. This ensures that the newly switched SP mode of the AP 502 does not induce any additional Co-Channel Interference (CCI) while the uplink EiRP budget can substantially benefit the user device 506.

In additional embodiments, the AP 502 may continue assessing new uplink and downlink RSSI of the user device 506, and if a further increase in user device's transmission power is needed, the AP 502 can request the user device 506 via any one of a DTPC frame, o-DS action frame, or the like.

As time progresses, the user device 506 may move to a different location where the uplink coverage is sufficient; however, the downlink coverage may be insufficient. In such a scenario (e.g., at a fourth time instance, T=T₄), the AP 502, already operating in the SP mode, may verify if the user device 506 is a sticky client or not. If the user device 506 is determined to be a non-sticky client, the AP 502 may increase the transmission power to provide sufficient downlink coverage to the user device 506. The increased downlink coverage area is depicted by a fifth dotted circle 512, which is greater than the previous downlink coverage area indicated by the first dotted circle 504. As a result, the AP 502 is able to adaptively control its mode of operation and power settings based on real-time measurements.

Although a specific embodiment for adaptive power mode control by an AP suitable for carrying out the various steps, processes, methods, and operations described herein is discussed with respect to FIG. 5, any of a variety of systems and/or processes may be utilized in accordance with embodiments of the disclosure. For example, the AP 502 may determine a current transmission power level of the user device 506 based on the uplink RSSI and RF proximity of the user device 506 with the AP 502. The AP 502 may determine the RF proximity of the user device 506 with the AP 502 based on one or more ranging schemes, such as Fine Timing Measurement (FTM) ranging, triangulation schemes, WiFi sensing, or the like. The elements depicted in FIG. 5 may also be interchangeable with other elements of FIGS. 1-4, 6A, 6B, and 7-10 as required to realize a particularly desired embodiment.

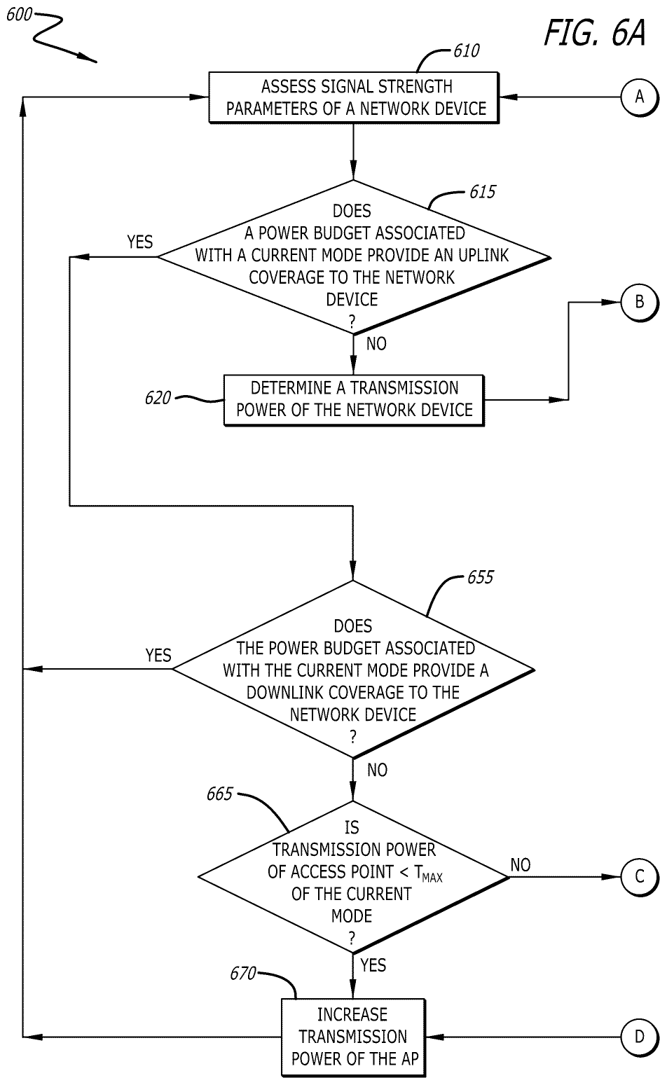

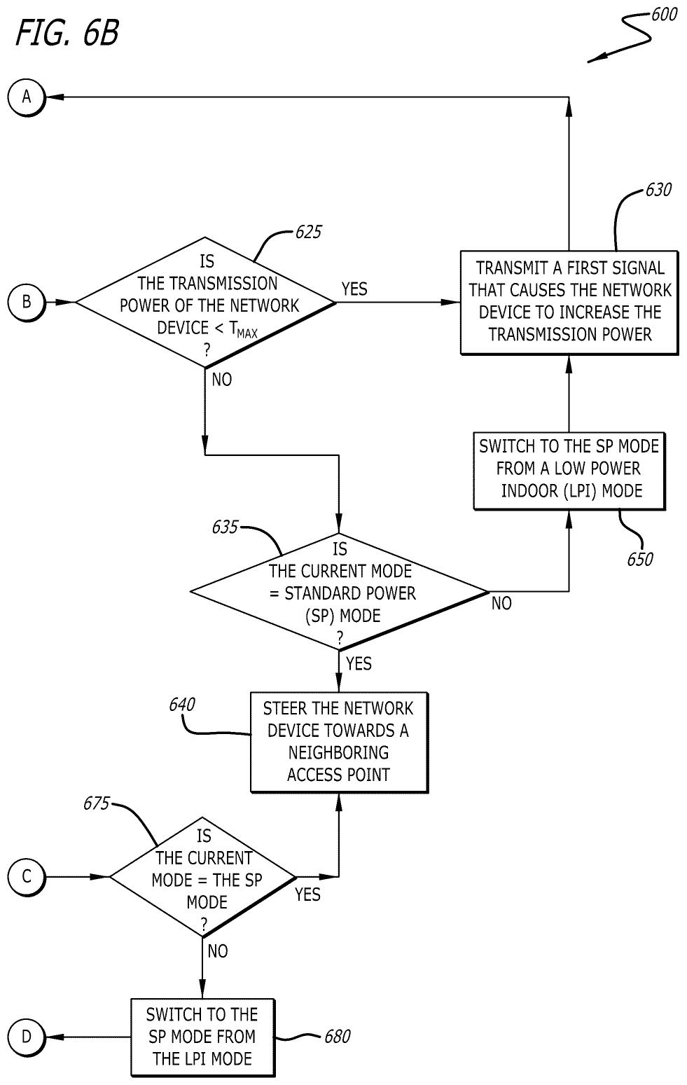

Referring collectively to FIGS. 6A and 6B, a flowchart showing a process 600 for adaptive power mode control by an AP in accordance with various embodiments of the disclosure is shown. In many embodiments, the process 600 may assess signal strength parameters of a network device (block 610). In numerous embodiments, the network device may be a user device. Examples of the user device may include, but are not limited to, a mobile device, a laptop, a smartphone, a tablet, a phablet, a desktop computer, Internet of Things (IoT) devices, gaming consoles, wearable devices, smart home assistants and appliances, entertainment and media devices, or the like. In numerous additional embodiments, the process 600 may be executed at the AP. The signal strength parameters may include an uplink signal strength parameter and a downlink signal strength parameter. Further, signal strength may be indicated via RSSI values or SNR values.

In a number of embodiments, the process 600 may determine whether a power budget associated with a current mode provides an uplink coverage to the network device (block 615). In an example, the current mode can be an LPI mode. In another example, the current mode can be an SP mode. The power budget associated with the current mode may be determined to provide the coverage if the uplink signal strength parameter is greater than an uplink signal strength threshold. However, if the uplink signal strength parameter is less than the uplink signal strength threshold, the process 600 may determine that the power budget associated with the current mode does not provide the uplink coverage to the network device.

Thus, if the power budget associated with the current mode does not provide the uplink coverage to the network device, in a variety of embodiments, the process 600 may determine a transmission power of the network device (block 620). The transmission power of the network device may be associated with how far a signal from the network device can travel. The higher the transmission power, the farther a signal can travel, and the more obstructions it can effectively penetrate. The process 600 may determine the transmission power of the network device based on the uplink signal strength parameter and RF proximity of the network device with the AP. The process 600 may determine the RF proximity of the network device with the AP based on one or more ranging schemes, such as FTM ranging, triangulation schemes, WiFi sensing, or the like.

In additional embodiments, the process 600 may determine whether the transmission power of the network device is less than the maximum transmission power of the network device (T_{MAX}) (block 625). A comparison of the transmission power of the network device with the maximum transmission power provides an indication of whether the insufficient uplink coverage is due to the network device transmitting at a lower power than available power or due to the maximum transmission power limit being reached.

If the transmission power of the network device is less than T_{MAX}, in further additional embodiments, the process 600 may transmit a first signal that causes the network device to increase the transmission power (block 630). For example, the process 600 may request the network device to increase the transmission power by transmitting any one of a DTPC frame, o-DS action frame, or the like. Further, the process 600 may again start assessing the signal strength parameters of the network device and repeat the process (block 610).

However, if the transmission power of the network device is equal to T_{MAX}, in several embodiments, the process 600 may determine if the current mode is the SP mode (block 635). For example, the process 600 may check the power mode settings of the AP to determine whether the AP is currently operating in the SP mode. Thus, if the current mode is already the SP mode, in still additional embodiments, the process 600 may steer the network device towards a neighboring AP (block 640). For example, if the transmission power of the network device is equal to T_{MAX} and also the current mode of the AP is the SP mode, the process 600 may determine that the network device cannot increase its transmission power any further. Thus, for continued network connectivity, the network device would need to connect to another AP

However, if the current mode is not the SP mode, the process 600 may switch to the SP mode from the LPI mode (block 650). In other words, if the current mode is not the SP mode, the process 600 may determine that the AP is operating in the LPI mode and the network device has maxed out on the transmission power limit available under the LPI mode. Therefore, the process 600 may switch the mode of operation to the SP mode, thus increasing an EiRP power budget of the network device under the SP mode. For example, the maximum transmission power of the network device increases from EiRP maximum_{LPI}—6 dB to EiRP maximum_{SP}—6 dB.

In further embodiments, the process 600 may transmit the first signal that causes the network device to increase the transmission power (block 630). Since the maximum transmission power of the network device is now increased to EiRP maximum_{SP}—6 dB, the process 600 may instruct the network device to leverage the increased power budget for improved uplink coverage. Further, the process 600 may again start assessing the signal strength parameters of the network device (block 610).

In several more embodiments, if the power budget associated with the current mode provides the uplink coverage to the network device, the process 600 may further determine whether the power budget associated with the current mode provides a downlink coverage to the network device (block 655). The power budget associated with the current mode may be determined to provide the coverage if the downlink signal strength parameter is greater than a downlink signal strength threshold. However, if the downlink signal strength parameter is less than the downlink signal strength threshold, the process 600 may determine that the power budget associated with the current mode does not provide the downlink coverage to the network device. In various embodiments, if the power budget associated with the current mode provides the downlink coverage to the network device, the process 600 may again start to assess signal strength parameters of the network device (block 610) and repeat the process.

However, if the power budget associated with the current mode does not provide the downlink coverage to the network device, in still more embodiments, the process 600 may determine if the transmission power of the AP is less than T_{MAX} of the current mode (block 665). For example, the process 600 may compare the transmission power of the AP with the T_{MAX} of the current mode.

If the transmission power of the AP is less than T_{MAX} of the current mode, in many further embodiments, the process 600 may increase the transmission power of the AP (block 670). For example, the process 600 may increase the transmission power of the AP in incremental steps, one step at a time. The process 600 may then return to assessing the signal parameters of the network device again (block 610).

However, if the transmission power of the AP is equal to T_{MAX} of the current mode, in still further embodiments, the process 600 may determine if the current mode is the SP mode (block 675). For example, the process 600 may check the power mode settings of the AP to determine whether the AP is currently operating in the SP mode.

Thus, if the AP is already operating in the SP mode, in more embodiments, the process 600 may steer the network device towards a neighboring access point (block 640). However, if the current mode is not the SP mode, the process 600 may switch to the SP mode from the LPI mode (block 680). In other words, if the current mode is not the SP mode, the process 600 may determine that the AP is operating in the LPI mode and the AP has maxed out on the transmission power limit available under the LPI mode. Therefore, the process 600 may switch the mode of operation to the SP mode to increase an EiRP power budget of the AP.

In still yet further embodiments, the process 600 may increase the transmission power of the AP (block 670). The transmission power of the network device may be increased to provide sufficient downlink coverage to the network device with a good RSSI value.

Although a specific embodiment for adaptive power mode control by an AP suitable for carrying out the various steps, processes, methods, and operations described herein is discussed with respect to FIGS. 6A and 6B, any of a variety of systems and/or processes may be utilized in accordance with embodiments of the disclosure. For example, in many additional embodiments, the process 600 may continuously monitor and measure an RF proximity with neighboring APs to determine a power budget (e.g., minimum and maximum transmission power levels for optimal cell size) of the AP without deviating from the scope of the disclosure. The elements depicted in FIGS. 6A and 6B may also be interchangeable with other elements of FIGS. 1-5 and 7-10 as required to realize a particularly desired embodiment.

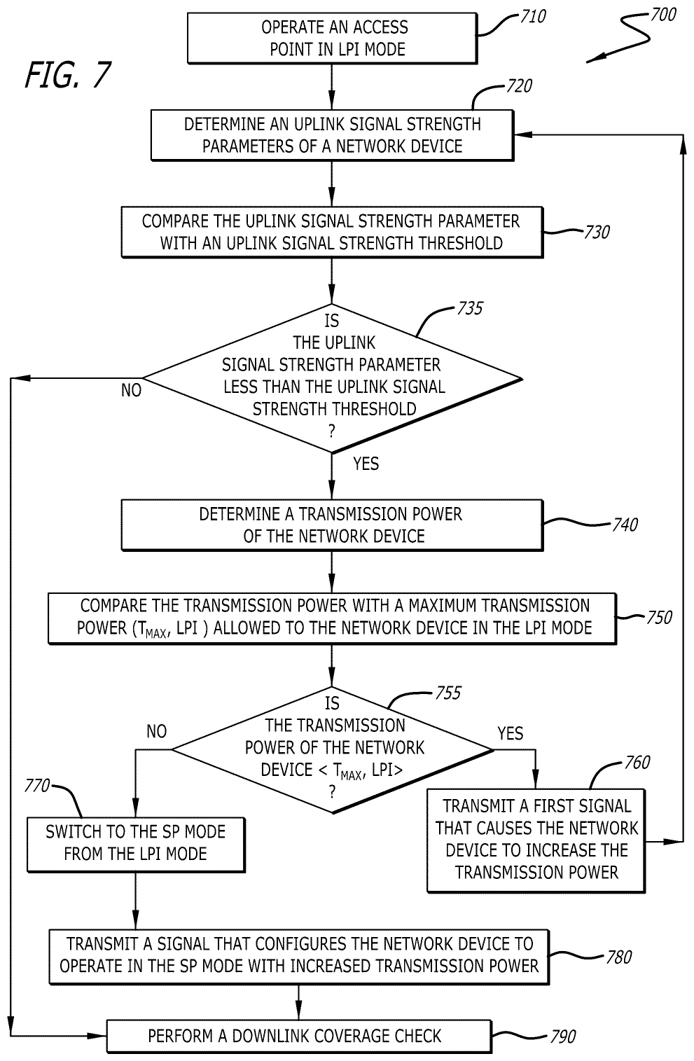

Referring to FIG. 7, a flowchart showing a process 700 for adaptive power mode control by an AP based on an uplink coverage check in accordance with various embodiments of the disclosure is shown. In a number of embodiments, the process 700 may operate the AP in LPI mode (block 710). In various embodiments, the LPI mode may help in reducing interference and saving energy by operating at a lower transmission power level, making it suitable for dense indoor environments such as offices or residential buildings. In numerous embodiments, EiRP budget in the LPI mode may be lower as compared to EiRP budget in an SP mode.

In many embodiments, the process 700 may determine an uplink signal strength parameter of a network device (block 720). In numerous additional embodiments, the network device may be a user device, a client station, or the like. Examples of the user device may include, but are not limited to, a mobile device, a laptop, a smartphone, a tablet, a phablet, a desktop computer, Internet of Things (IoT) devices, gaming consoles, wearable devices, smart home assistants and appliances, entertainment and media devices, or the like. In more embodiments, the process 700 may assess the uplink signal strength parameter based on an uplink traffic from the network device to the AP. In an example, the uplink signal strength parameter can be uplink RSSI or uplink SNR. In yet additional embodiments, the process 700 may be configured to discard the uplink traffic corresponding to non-Wi-Fi contentions from being considered during uplink signal strength determination. Presence of non-Wi-Fi contentions in the uplink traffic may indicate a noisy environment.

In several embodiments, the process 700 may compare the uplink signal strength parameter with an uplink signal strength threshold (block 730). The process 700 may compare the assessed uplink signal strength parameter with the uplink signal strength threshold to determine whether the signal strength is sufficient for reliable uplink communication. For example, if the AP has an uplink signal strength threshold set at a predefined dBm, the process 700 may compare the measured uplink RSSI of the network device with the predefined dBm. In many examples, the uplink signal strength threshold can be based on a minimum acceptable signal strength that ensures reliable uplink communication.

After comparing the uplink signal strength parameter with the uplink signal strength threshold, in further additional embodiments, the process 700 may determine whether the uplink signal strength parameter is less than the uplink signal strength threshold (block 735). If the uplink signal strength is below the uplink signal strength threshold, in several more embodiments, the process 700 may determine the transmission power of the network device (block 740). The transmission power of the network device may be associated with how far a signal from the network device can travel. The higher the transmission power, the farther a signal can travel, and the more obstructions it can effectively penetrate. The process 700 may determine the transmission power of the network device based on the uplink signal strength parameter and RF proximity of the network device with the AP. The process 700 may determine the RF proximity of the network device with the AP based on one or more ranging schemes, such as FTM ranging, triangulation schemes, WiFi sensing, or the like.

In additional embodiments, the process 700 may compare the transmission power with a maximum transmission power (T_{MAX,LPI}) allowed to the network device in the LPI mode (block 750). A comparison of the transmission power of the network device with the maximum transmission power (T_{MAX, LPI}) provides an indication of whether the insufficient uplink coverage is due to the network device transmitting at a lower power than available power or due to the maximum transmission power limit being reached.

After comparing the transmission power with the maximum transmission power allowed to the network device in the LPI mode, in further embodiments, the process 700 may determine if the transmission power of the network device is less than T_{MAX, LPI} (block 755). The transmission power of the network device being less than T_{MAX, LPI} may indicate that the insufficient uplink coverage is due to the network device transmitting at a lower power than available power.

Thus, if the transmission power is less than T_{MAX, LPI}, in further additional embodiments, the process 700 may transmit a first signal that causes the network device to increase the transmission power (block 760). For example, the process 700 may request the network device to increase the transmission power by transmitting any one of a DTPC frame, o-DS action frame, or the like. Further, the process 700 may again determine the uplink signal strength parameters of the network device (block 720).

However, in still additional embodiments, if the transmission power is equal to T_{MAX, LPI}, the process 700 may switch to the SP mode from the LPI mode (block 770). For example, the process 700 may determine that the AP is operating in the LPI mode and the network device has maxed out on the transmission power limit available under the LPI mode. Therefore, the process 700 may switch the mode of operation of the AP to the SP mode, thus increasing an EiRP power budget of the network device under the SP mode. For example, the maximum transmission power of the network device increases from EiRP maximum_{LPI}—6 dB to EiRP maximum_{SP}—6 dB in response to the switching of the AP to the SP mode. In still further embodiments, the process 700 may continue to operate the AP at the same transmission power that was used prior to switching to the SP mode, even after switching to the SP mode. Switching to the SP mode may increase an EiRP budget of the network device.

In yet more embodiments, the process 700 may transmit a signal that configures the network device to operate in the SP mode with increased transmission power (block 780). The network device on receipt of the signal may start operating in the SP mode and can transmit at a higher transmission power.

In still yet more embodiments, the process 700 may perform a downlink coverage check (block 790). In many further embodiments, if the uplink signal strength parameter is more than the uplink signal strength threshold, the process 700 may continue with its current operations and perform the downlink coverage check (block 790). This check may involve assessing the downlink coverage area of the network device to ensure that the RF signal transmitted by the AP is reaching the network device.

Although a specific embodiment for adaptive power mode control by an AP based on the uplink coverage check suitable for carrying out the various steps, processes, methods, and operations described herein is discussed with respect to FIG. 7, any of a variety of systems and/or processes may be utilized in accordance with embodiments of the disclosure. For example, in still yet further embodiments, the process 700 may perform the downlink coverage check prior to or simultaneously with the uplink coverage check. The elements depicted in FIG. 7 may also be interchangeable with other elements of FIGS. 1-5, 6A, 6B, and 8-10 as required to realize a particularly desired embodiment.

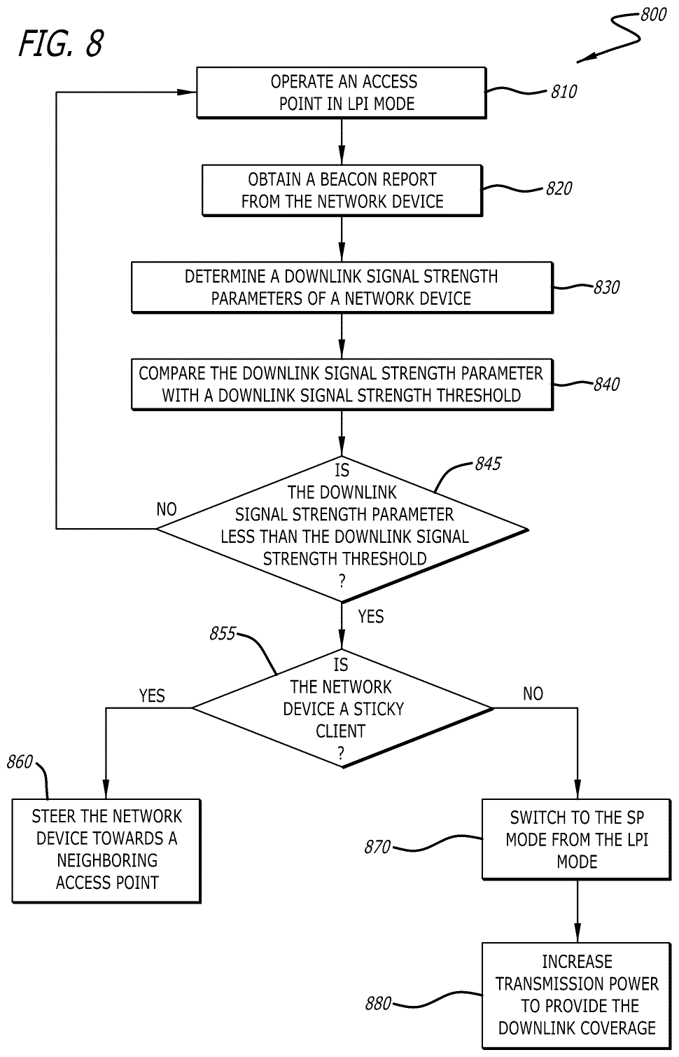

Referring to FIG. 8, a flowchart showing a process 800 for adaptive power mode control by an AP based on a downlink coverage check in accordance with various embodiments of the disclosure is shown. In many embodiments, the process 800 may operate the AP in LPI mode (block 810). In various embodiments, the LPI mode may help in reducing interference and saving energy by operating at a lower transmission power level, making it suitable for dense indoor environments such as offices or residential buildings. In numerous embodiments, EiRP budget in the LPI mode may be lower as compared to EiRP budget in an SP mode.

In a number of embodiments, the process 800 may obtain a beacon report from a network device (block 820). In a variety of embodiments, the beacon report may include, for example, a timestamp indicating the exact time of report generation, channel information detailing the current or monitored channel number and bandwidth, and signal strength measurements such as downlink RSSI from associated and neighboring APs. Additionally, the beacon report may include neighbor information, for example, nearby APs' SSID, a BSSID, signal strength, and channel details. In numerous additional embodiments, the network device can be a user device, a client station, or the like. Examples of the user device may include, but are not limited to, a mobile device, a laptop, a smartphone, a tablet, a phablet, a desktop computer, Internet of Things (IoT) devices, gaming consoles, wearable devices, smart home assistants and appliances, entertainment and media devices, or the like. The beacon report can be either solicited or sent unsolicited by the user device. When solicited, the process 800 may request specific information (for example, the signal strength measurements and the neighbor information) from the user device. Conversely, the user device can also transmit unsolicited beacon reports, without a prior request from the AP, to share real-time observations and measurements with the AP.

In further embodiments, the process 800 may determine a downlink signal strength parameter of the network device (block 830). Based on the beacon report, the process 800 may determine the downlink signal strength parameter of the network device. In an example, the downlink signal strength parameter can include a downlink RSSI, a downlink SNR, or the like. Determination of the downlink signal strength parameter may involve extracting, from the beacon report, relevant metrics that can indicate a quality of the downlink signal received by the network device from the AP.

In more embodiments, the process 800 may compare the downlink signal strength parameter with a downlink signal strength threshold (block 840). In other words, the process 800 may compare the determined downlink signal strength parameter with the downlink signal strength threshold that represents a minimum acceptable signal strength for reliable and seamless downlink communication. For example, if the AP has set a particular downlink signal strength threshold for acceptable downlink signal strength, the process 800 may compare the reported downlink RSSI value of the network device with the set threshold to determine if the downlink signal is adequate.

In further additional embodiments, the process 800 may determine whether the downlink signal strength parameter is less than the downlink signal strength threshold (block 845). The downlink signal strength parameter being less than the downlink signal strength threshold may indicate inadequate downlink coverage for the network device. However, the downlink signal strength parameter being greater than the downlink signal strength threshold may indicate adequate downlink coverage for the network device. If the downlink signal strength parameter is greater than the downlink signal strength threshold, in additional embodiments, the process 800 may continue to operate the AP in the LPI mode (block 810).

However, if the downlink signal strength parameter is less than the downlink signal strength threshold, in yet additional embodiments, the process 800 may determine whether the network device is a sticky client (block 855). In other words, the process 800 may check if the network device remains connected to the current AP even when neighboring APs offer better performance. For example, the process 800 may identify whether the network device tends to stay connected to the AP despite having access to stronger downlink signals from neighboring APs. This can happen if the network device is slow to switch APs due to its settings or user preferences.

If the network device is a sticky client, in still yet additional embodiments, the process 800 may steer the network device to a neighboring AP (block 860). For example, the neighboring AP may be capable of providing a better downlink signal strength to the network device. In yet further embodiments, steering the network device may include guiding the network device to disconnect from the current AP and connect to the neighboring AP with the stronger downlink signal. For example, the process 800 may transmit management frames to the network device, suggesting the network device to switch to the neighboring AP that has a downlink RSSI value greater than the current AP.

However, if the network device is a non-sticky client, in several embodiments, the process 800 may switch to the SP mode from the LPI mode (block 870). The SP mode may allow the AP to operate at a higher transmission power to improve downlink coverage and signal strength. In other words, switching to the SP mode may increase the EiRP budget of the AP, thus, providing the AP access to higher transmission power.

In several additional embodiments, the process 800 may increase transmission power to provide the downlink coverage (block 880). For example, the process 800 may cause the AP to increase the transmission power. Increase in the transmission power may improve the downlink signal strength and quality of signal received by the network device. For example, after switching to the SP mode, the AP can increase the transmission power to the maximum allowed by regulations under the SP mode.

Although a specific embodiment for adaptive power mode control by an AP based on a downlink coverage check suitable for carrying out the various steps, processes, methods, and operations described herein is discussed with respect to FIG. 8, any of a variety of systems and/or processes may be utilized in accordance with embodiments of the disclosure. For example, in still yet further embodiments, the process 800 may perform an uplink coverage check of an AP prior to, after, or simultaneously with the downlink coverage check. The elements depicted in FIG. 8 may also be interchangeable with other elements of FIGS. 1-7, 9, and 10 as required to realize a particularly desired embodiment.

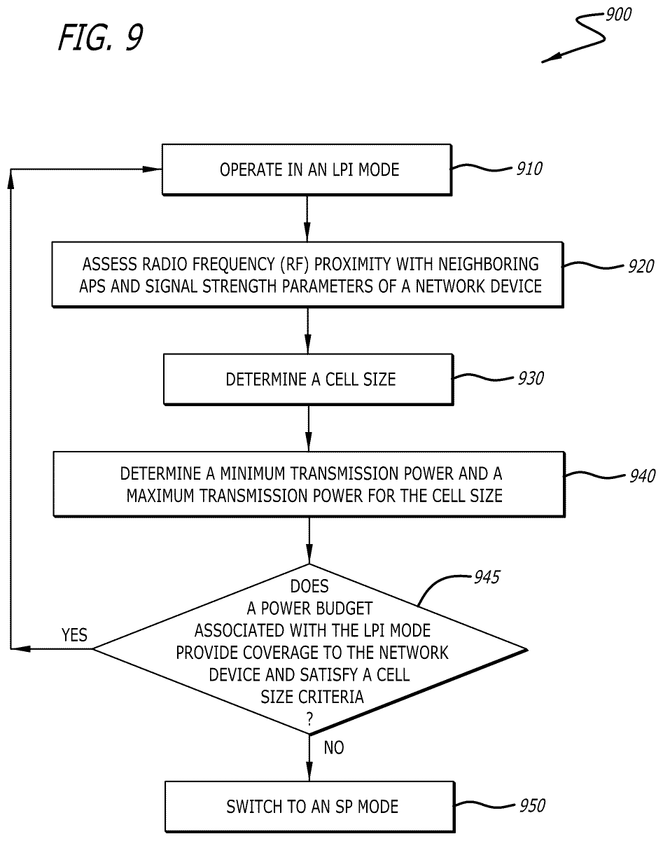

Referring to FIG. 9, a flowchart showing a process 900 for adaptive power mode control by an AP in accordance with various embodiments of the disclosure is shown. In many embodiments, the process 900 may operate in an LPI mode (block 910). For example, the process 900 may cause an AP to operate in the LPI mode. In various embodiments, the LPI mode may help in reducing interference and saving energy by operating at a lower transmission power level, making it suitable for dense indoor environments such as offices or residential buildings. In numerous embodiments, EiRP budget in the LPI mode may be lower as compared to EiRP budget in an SP mode.

In a number of embodiments, the process 900 may assess an RF Proximity with neighboring APs and signal strength parameters of a network device (block 920). In other words, the process 900 may continuously or periodically monitor and measure the RF proximity of the AP with neighboring APs and the signal strength parameters of the network device connected to the AP. In various embodiments, assessing the RF Proximity with neighboring APs may include assessing the RSSI from the neighboring APs. For example, the process 900 may actively or passively scan signals from neighboring APs and assess their RSSI and quality. By analyzing these RF signals, the process 900 can identify the boundaries of coverage areas of the neighboring APs. Further, assessing the signal strength parameters of the network device may include assessing the downlink and uplink RSSIs of the network device. Examples of the network device may include a laptop, a smartphone, a sensor, an IoT device, or the like. Assessment of the RF Proximity with neighboring APs and the signal strength parameters of the network device may enable the AP to understand the wireless environment and spatial relationship with other network elements.

In numerous embodiments, the process 900 may determine a cell size (block 930). In numerous additional embodiments, the cell size may refer to a coverage area that the AP can serve. The cell size may be determined based on various factors such as RF proximity with neighboring APs or network nodes, physical obstructions, and an overall layout of the wireless network. In additional embodiments, the cell size may be determined in such a manner that ensures sufficient overlap between RF coverage areas of adjacent APs, allowing connected user devices to seamlessly roam between neighboring APs without losing network connection.

In a variety of embodiments, the process 900 may determine a minimum transmission power and a maximum transmission power for the cell size (block 940). In additional embodiments, the minimum transmission power may correspond to the lowest power level at which the AP can still provide adequate downlink coverage and maintain reliable communication with connected user devices located at the edges of its cell. On the other hand, the maximum transmission power may correspond to the highest power level the AP can use to extend its coverage area as much as possible without causing interference with the neighboring APs.

In a variety of embodiments, the process 900 may determine whether a power budget associated with the LPI mode provides coverage to the network device and satisfies a cell size criterion (block 945). In other words, the process 900 may evaluate whether the current power budget in the LPI mode is sufficient to cover the network device and also meet the cell size criteria. For example, the transmission power allowed in the LPI mode may be less than the minimum transmission power for the determined cell size. In such a scenario, the process 900 may determine that the power budget associated with the LPI mode is insufficient to satisfy the cell size criterion. Further, if the power budget in the LPI mode does not provide adequate downlink and uplink coverage to a network device connected to the AP, the process 900 may determine that the power budget associated with the LPI mode is insufficient. In more embodiments, determining whether the power budget associated with the LPI mode is sufficient may involve comparing the calculated transmission power requirements with the allowable power usage in the LPI mode. Further, the determination can be based on comparing the uplink and downlink signal strength parameters of a connected network device with uplink and downlink signal strength thresholds, respectively. In yet more embodiments, if the power budget of the LPI mode is sufficient, the process 900 may continue operating the AP in the LPI mode (block 910).

However, in still yet more embodiments, if the power budget of the LPI mode is insufficient, the process 900 may switch to an SP mode (block 950). In other words, if the power budget associated with the LPI mode cannot provide coverage to the network device and satisfy the cell size criterion, the process 900 may switch the AP to the SP mode. For example, if the minimum transmission power required for the cell size is greater than the allowable power usage in the LPI mode, the process 900 may switch the AP from the LPI mode to the SP mode. Further, the process 900 can switch the AP from the LPI mode to the SP mode if the power budget in the LPI mode does not provide adequate downlink and uplink coverage to the network device. In numerous embodiments, EiRP budget in the LPI mode may be lower as compared to EiRP budget in the SP mode. In other words, the SP mode may allow the AP to use higher transmission power to extend its coverage area and improve signal strength.

Although a specific embodiment for adaptive power mode control by an AP suitable for carrying out the various steps, processes, methods, and operations described herein is discussed with respect to FIG. 9, any of a variety of systems and/or processes may be utilized in accordance with embodiments of the disclosure. For example, in still yet further embodiments, the process 900 may obtain a beacon report from a network device to determine the signal strength parameters without deviating from the scope of the disclosure. The elements depicted in FIG. 9 may also be interchangeable with other elements of FIGS. 1-8 and 10 as required to realize a particularly desired embodiment.

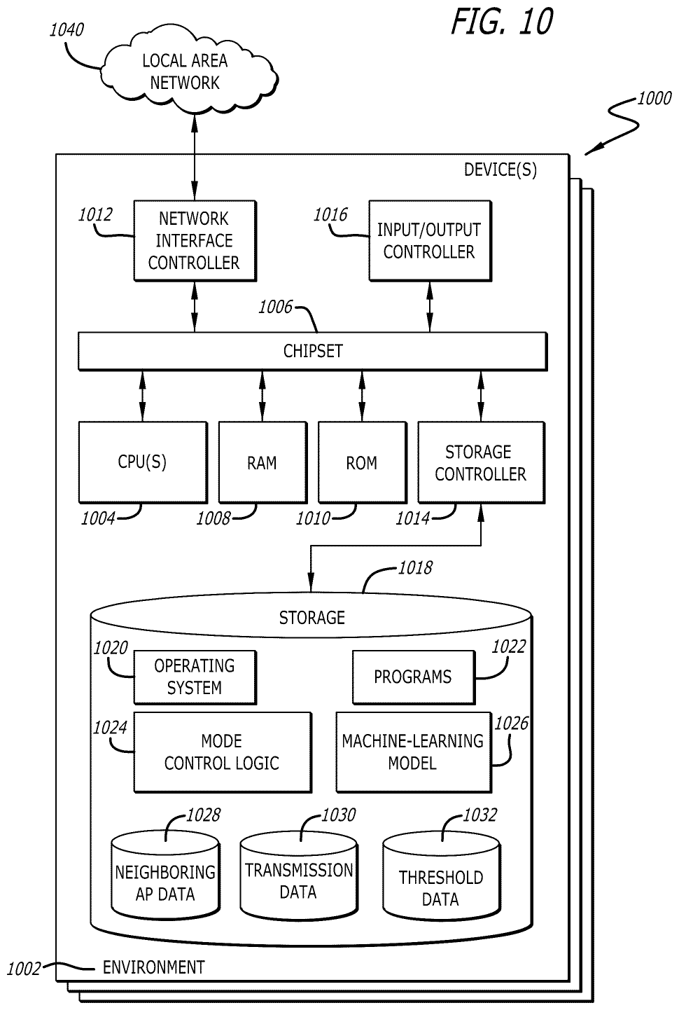

Referring to FIG. 10, a conceptual block diagram of a device 1000 suitable for configuration with a device discovery logic, in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many nonlimiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022, neighboring AP data 1028, transmission power data 1030, and threshold data 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform the functions described herein. The virtualization layer may generally support a virtual resource that performs at least a portion of the techniques described herein.

In many further embodiments, the device 1000 may include a mode control logic 1024. The mode control logic 1024 can be configured to perform one or more of the various steps, processes, operations, and/or other methods that are described above. Often, the mode control logic 1024 can be a set of instructions stored within a non-volatile memory that, when executed by the processor(s)/controller(s) 1004 can carry out these steps, etc. In certain embodiments, the mode control logic 1024 may perform various operations related to dynamic adjustment of transmission power and switching of modes of the device 1000. The mode control logic 1024 may be configured to monitor and assess signal strength parameters of the network device and transmission power of the network device to ensure that the network device has a seamless communication. The mode control logic 1024 may evaluate whether a power budget associated with the LPI mode provides an uplink coverage and a downlink coverage to one or more network devices connected to the device 1000. In other words, the mode control logic 1024 may measure connected devices' uplink and downlink RSSIs to determine an optimal power mode (e.g., the LPI mode or the SP mode) for the device 1000, for example, an AP. For example, the mode control logic 1024 may determine whether to switch the device 1000 from the LPI mode to the SP mode, from the SP mode to the LPI mode, or continue operating in the current mode.

In various embodiments, the storage 1018 can include the neighboring AP data 1028. The neighboring AP data 1028 may include location information of a plurality of APs deployed in a neighborhood of the device 1000. The neighboring AP data 1028 may further include RF proximity information, RF density information, neighboring APs' cell sizes, interference levels with neighboring APs, or the like. In numerous additional embodiments, the interference levels with neighboring APs may include details regarding co-channel interference and adjacent channel interference. The neighboring AP data 1028 may be utilized by the mode control logic 1024 for determining a cell size of the device 1000. In numerous embodiments, the neighboring AP data 1028 can further include information regarding roaming Service Level Agreements (SLAs) that define standards for service quality during roaming between neighboring APs. For example, the roaming SLAs may define parameters such as an expected time for a user device to connect to a new AP, the minimum acceptable signal strength and quality to trigger assisted roaming, or the like. The neighboring AP data 1028 can be further utilized by the device 1000 for resource management.

In still more embodiments, the storage 1018 can include the transmission power data 1030. The transmission power data 1030 may include minimum and maximum transmission power levels defined for a required cell size of the device 1000. Further, the transmission power data 1030 may include current transmission power settings of the device 1000 and power budgets for different modes (e.g., LPI and SP modes) of operation of the device 1000. The transmission power data 1030 may enable the mode control logic 1024 in determining whether the device 1000 (e.g., the AP) needs to increase transmission power, switch modes, or maintain current settings to ensure optimal coverage and communication quality.

In a number of embodiments, the storage 1018 can include threshold data 1032. The threshold data 1032 may store threshold data associated with a minimum and a maximum power budget allowed for either an LPI mode or an SP mode of the device 1000. Further, the threshold data 1032 may vary based on the type of network. In many embodiments, the threshold data 1032 may include uplink signal strength threshold and downlink signal strength threshold utilized by the mode control logic 1024 for determining whether to increase transmission power, switch modes, or maintain current settings for the device 1000.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model(s) 1026 can be configured to generate inferences to make predictions or draw conclusions from data. An inference can be considered the output of a process of applying a model to new data. This can occur by learning from at least the neighboring AP data 1028, the transmission power data 1030, and the threshold data 1032, and utilizing the learning to predict future outcomes. For example, the ML model(s) 1026 can be trained to predict RF proximity based on RSSI or beacons transmitted by the neighboring APs. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a dynamic proxying logic for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although a specific embodiment for a conceptual block diagram of the device 1000 suitable for configuration with the mode control logic suitable for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a transceiver operable in one of a Low Power Indoor (LPI) mode or a Standard Power (SP) mode; and
a memory communicatively coupled to the processor, wherein the memory comprises a mode control logic that is configured to:
assess one or more signal strength parameters of a network device communicatively coupled to the device;
evaluate, based on the one or more signal strength parameters, whether a power budget associated with the LPI mode provides an uplink coverage and a downlink coverage to the network device; and
determine whether to switch the transceiver from the LPI mode to the SP mode based on the evaluation.

2. The device of claim 1, wherein the one or more signal strength parameters include an uplink signal strength parameter.

3. The device of claim 2, wherein the uplink signal strength parameter corresponds to a Received Signal Strength Indicator (RSSI) uplink value of the network device.

4. The device of claim 2, wherein to assess the uplink signal strength parameter, the mode control logic is further configured to:
compare the uplink signal strength parameter with an uplink signal strength threshold; and
determine whether the uplink signal strength parameter is less than the uplink signal strength threshold based on the comparison.

5. The device of claim 4, wherein in response to determining that the uplink signal strength parameter is less than the uplink signal strength threshold, the mode control logic is further configured to determine a transmission power of the network device.

6. The device of claim 5, wherein the mode control logic is further configured to compare the transmission power with a maximum transmission power allowed to the network device in the LPI mode.

7. The device of claim 6, wherein the mode control logic determines to maintain the transceiver in the LPI mode in response to the transmission power being less than the maximum transmission power.

8. The device of claim 6, wherein the mode control logic is further configured to transmit, in response to the transmission power being less than the maximum transmission power, a signal that causes the network device to increase the transmission power.

9. The device of claim 6, wherein, in response to the transmission power being equal to the maximum transmission power, the mode control logic evaluates that the power budget associated with the LPI mode is insufficient to provide the uplink coverage to the network device.

10. The device of claim 9, wherein, in response to the power budget being insufficient, the mode control logic is further configured to:
switch the transceiver from the LPI mode to the SP mode; and
transmit, based on the transceiver operating in the SP mode, a signal that configures the network device to operate in the SP mode.

11. The device of claim 1, wherein the one or more signal strength parameters include a downlink signal strength parameter.

12. The device of claim 11, wherein the downlink signal strength parameter corresponds to an RSSI downlink value of the network device.

13. The device of claim 11, wherein to assess the downlink signal strength parameter, the mode control logic is further configured to:
obtain a beacon report from the network device;
determine the downlink signal strength parameter from the beacon report; and
compare the downlink signal strength parameter with a downlink signal strength threshold.

14. The device of claim 13, wherein, in response to the downlink signal strength parameter being less than the downlink signal strength threshold, the mode control logic evaluates that the power budget associated with the LPI mode is insufficient to provide the downlink coverage to the network device.

15. The device of claim 14, wherein the mode control logic is further configured to determine whether the network device is a sticky client.

16. The device of claim 15, wherein, based on the network device being a non-sticky client, the mode control logic is further configured to:
switch the transceiver from the LPI mode to the SP mode; and
increase a downlink transmission power of the transceiver.

17. The device of claim 16, wherein the mode control logic is further configured to:
assess a Radio Frequency (RF) proximity of the device with at least one neighboring device; and
determine a device cell size based on the assessed RF proximity with the at least one neighboring device.

18. The device of claim 17, wherein the mode control logic is further configured to identify a maximum downlink transmission power allowed in the SP mode based on the determined device cell size.

19. A device, comprising:
a processor;
a transceiver operable in one of a Low Power Indoor (LPI) mode or a Standard Power (SP) mode; and
a memory communicatively coupled to the processor, wherein the memory comprises a mode control logic that is configured to:
assess one or more signal strength parameters of a network device communicatively coupled to the device and a Radio Frequency (RF) proximity of the device with at least one neighboring device;
evaluate, based on the one or more signal strength parameters and the RF proximity, whether a power budget associated with the LPI mode provides an uplink coverage and a downlink coverage to the network device; and
determine whether to switch the transceiver from the LPI mode to the SP mode based on the evaluation.

20. A method, comprising:
assessing one or more signal strength parameters of a network device in communication with an access point;
evaluating, based on the one or more signal strength parameters, whether a power budget associated with a Low Power Indoor (LPI) mode of the access point provides an uplink coverage and a downlink coverage to the network device; and
determining whether to switch the access point from the LPI mode to a Standard Power mode based on the evaluation.
